(19) United States
(12) Patent Application Publication
(10) Pub. No.: US 2007/0138319 A1
(43) Pub. Date: Jun. 21, 2007

(54) Lawn chemical application system

(76) Inventor: Brian Thornton, Hot Springs, AR (US)

Correspondence Address: Kyla D. Cummings;Speed Law Firm, Suite 1200, 111 Center Street, Little Rock, AR, 72201, US

(21) Appl. No.: 11/700,669

(22) Filed: Jan. 31, 2007

Related U.S. Application Data
(63) Continuation-in-part of application No. 11/319,114, filed on Dec. 27, 2005.
Application No. 11/319,114 is a continuation of application No. 10/916,226, filed on Aug. 10, 2004, now Pat. No. 7,011,254.
Application No. 10/916,226 is a division of application No. 09/761,940, filed on Jan. 17, 2001.

(51) Int. Cl. A62C 5/02; B05B 7/28

(52) U.S. Cl. 239/317; 239/10; 239/565

(57) ABSTRACT

A lawn chemical application system is disclosed. The system comprises a dispenser having a lower chamber, an upper chamber, an upstream opening, and a downstream opening. The dispenser may be formed by a tee connector and a cylinder secured to an upper opening of the tee connector. Powered valves are operably connected to the upstream and downstream openings of the dispenser. The powered valves may be wired to open and close simultaneously. A lower portion of the upper chamber may be disposed below an upper portion of the lower chamber and above a lower portion of the lower chamber, leaving the lower portion of the lower chamber unobstructed over substantially its entire length. The lower portion of the upper chamber may have a plurality of openings to provide for adequate mixing of water with the chemicals stored in the upper chamber. In operation, soluble matter or other chemicals are placed in the upper chamber of the dispenser, and the two valves are opened simultaneously. Water flows through the first powered valve and into the dispenser, where the water is mixed with soluble matter or other chemicals stored in the upper chamber of the tee. The solution or mixture then passes from the dispenser, through the second powered valve, to one or more sprinkler heads of the irrigation system. When the application is finished, the valves are closed simultaneously.

### CROSS-REFERENCE TO RELATED APPLICATIONS

This application is a continuation-in-part of co-pending U.S. patent application Ser. No. 11/319,114, filed Dec. 27, 2005. U.S. patent application Ser. No. 11/319,114 is a continuation of U.S. patent application Ser. No. 10/916,226, filed Aug. 10, 2004, now U.S. Pat. No. 7,011,254. U.S. patent application Ser. No. 10/916,226 is a divisional of U.S. patent application Ser. No. 09/761,940, filed Jan. 17, 2001. Each of the aforementioned related patent applications is herein incorporated by reference in its entirety.

### BACKGROUND OF THE INVENTION

This invention relates to irrigation systems, and more particularly, to a lawn chemical application system integrated with an irrigation system.

It is generally known in the art to integrate a chemical dispenser with an irrigation system. This allows the irrigation system to apply chemicals such as fertilizer to a lawn or other area. Using an irrigation system to apply such chemicals offers many advantages over manual application. For example, it can save a tremendous amount of time and labor and can provide for a more even application of the chemicals.

Although they offer many advantages, known lawn chemical dispensing systems still suffer from a number of disadvantages. For example, such systems have often been complex and have often been difficult and costly to assemble and install. They have typically been difficult to use and have often required service calls from specially trained technicians. Known systems have often obstructed the flow of water too much, have often provided insufficient mixing of the chemicals with the water, and have often lacked flexibility in the types and forms of chemicals that may be used in the systems. Known systems have also failed to provide protection against undesired seepage of chemicals from the dispenser into the irrigation system when the irrigation system was not in use. Such seepage can lead to high concentrations of chemicals in isolated areas of a system that can lead to uneven application or over-application of the chemicals. It is also undesirable to allow high concentrations of potentially corrosive chemicals to seep into and remain in an irrigation system for long periods of time between uses.

### SUMMARY OF THE INVENTION

It is therefore an object of the present invention to provide a lawn chemical application system that is easy and inexpensive to manufacture and install and that is easy to use.

It is a further object of the present invention to provide a system of the above type that provides for adequate mixing of water and chemicals while avoiding unnecessary obstruction to the flow of water.

It is a still further object of the present invention to provide a system of the above type that protects against undesirable seepage of chemicals into the system when the system is not in use.

It is a still further object of the present invention to provide a system of the above type that provides for even application of chemicals and that protects against over-application of chemicals.

It is a still further object of the present invention to provide a system of the above type that may be used to replace a master valve of an existing irrigation system or in place of a master valve in a new irrigation system.

Toward the fulfillment of these and other objects and advantages, the system of the present invention comprises a dispenser having a lower chamber, an upper chamber, an upstream opening, and a downstream opening. The dispenser may be formed by a tee connector and a cylinder secured to an upper opening of the tee connector. Powered valves are operably connected to the upstream and downstream openings of the dispenser. The powered valves may be wired to open and close simultaneously. A lower portion of the upper chamber may be disposed below an upper portion of the lower chamber and above a lower portion of the lower chamber, leaving the lower portion of the lower chamber unobstructed over substantially its entire length. The lower portion of the upper chamber may have a plurality of openings to provide for adequate mixing of water with the chemicals stored in the upper chamber. In operation, soluble matter or other chemicals are placed in the upper chamber of the dispenser, and the two valves are opened simultaneously. Water flows through the first powered valve and into the dispenser, where the water is mixed with soluble matter or other chemicals stored in the upper chamber of the dispenser. The solution or mixture then passes from the dispenser, through the second powered valve, and to one or more sprinkler heads of the irrigation system. When the application is finished, the valves are closed simultaneously.

### BRIEF DESCRIPTION OF THE DRAWINGS

The above brief description, as well as further objects, features and advantages of the present invention will be more fully appreciated by reference to the following detailed description of the presently preferred but nonetheless illustrative embodiments in accordance with the present invention when taken in conjunction with the accompanying drawings, wherein:

FIG. 1 is an elevation view of a portion of a system of the present invention;

FIG. 2 is an enlarged, partially exploded view of a dispenser the present invention;

FIG. 3 is an enlarged, partially exploded view of an alternate embodiment of a dispenser of the present invention;

FIG. 4 is a partial, perspective view of a lower portion of an upper chamber for a dispenser of the present invention;

FIG. 5 is an enlarged, partially exploded view of an upper portion of an upper chamber for a dispenser of the present invention; and

FIG. 6 is a schematic view of an irrigation system incorporating the lawn chemical application system of the present invention.

FIG. 7 is a perspective view of a container of embodiments of the present invention.

FIG. 8 is a section view of a portion of an embodiment of the lawn chemical application system and a lid-manipulating device disposed thereon.

FIG. 8A is a perspective section view of a dispenser of the lawn chemical application system and its associated lid.

FIG. 9 is a perspective view of the lid-manipulating device and a pressure release tool therewith.

FIG. 10 is a perspective section view of the dispenser, its associated lid, and the pressure release tool.

FIG. 10A is an end view of an outer surface of the lid of the lawn chemical application system.

FIG. 10B is an end view of an inner surface of the lid with a pressure release mechanism disposed therethrough.

FIG. 11 is a cross-sectional view of the pressure release mechanism of FIG. 10B.

FIG. 12 is a downward view through the dispenser of FIG. 8A with the container of FIG. 7 located within a bore of the dispenser. Portions of the container and its contents are removed to show the bottom of the dispenser.

FIG. 13 is an end view of the container of FIG. 7.

### DETAILED DESCRIPTION

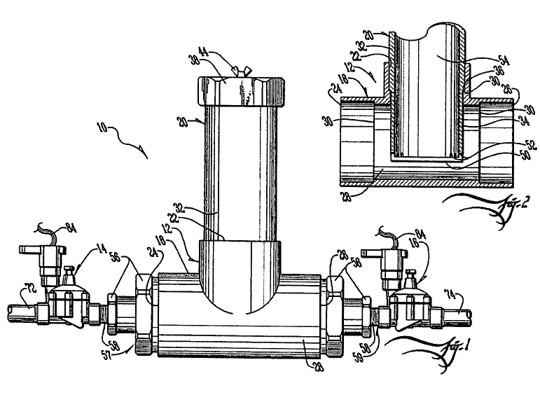

Referring to FIG. 1, the reference numeral 10 refers in general to a lawn chemical application system of the present invention. The system comprises a dispenser 12 and powered valves 14 and 16.

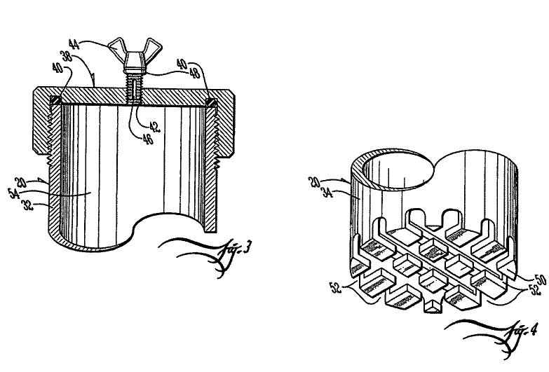

As best seen in FIG. 2, the dispenser 12 of the present invention may be formed by a connector such as a tee connector 18 and a cylinder 20 secured to an upper opening 22 of the tee connector 18. The connector 18 also has upstream and downstream openings 24 and 26 and forms a lower chamber 28. Shoulders 30 are formed around inside diameters of the connector 18 near the upstream, downstream, and upper openings 24, 26, and 22. The tee connector 18 is preferably made from Schedule 40 PVC rated to 200 psi, and is preferably a 4″ or 6″ tee connector 18. It is understood that the connector 18 may be made from a wide variety of materials, in a wide variety of strength, shapes and sizes.

The cylinder 20 has an upper portion 32 and a lower portion 34 having different outside diameters. The outside diameter of the upper portion 32 is greater than the outside diameter of the lower portion 34 so that a shoulder 36 is formed where the upper and lower portions meet. Shoulder 36 of the cylinder 20 mates with shoulder 30 of the upper opening 22 of the connector 18 to help secure the connector 18 and cylinder 20. Referring to FIG. 3, the top of the cylinder 20 is threaded. A threaded lid 38 having an O-ring 40 is provided to create a water tight seal at the top of the cylinder 20. A threaded opening 42 is provided through the lid 38. A bolt or screw 44 is fitted within the threaded opening 42. The bolt 44 has a channel 46 formed over a lower portion of at least one side, and an O-ring 48 is used to provide a water tight seal between the bolt 44 and lid 38. The bolt 44 may of course be made from any number of different materials but is preferably plastic or a similar material to reduce the chances of stripping the mating threads in the threaded opening 42.

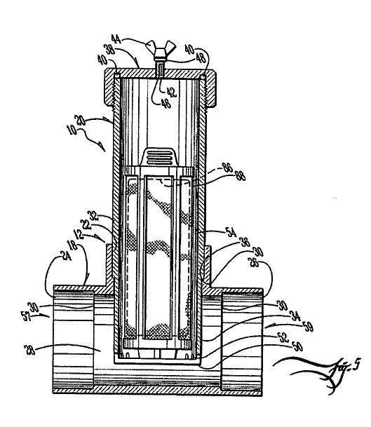

As best seen in FIG. 4, the lower portion 34 of the cylinder 20 has a bottom 50. A plurality of openings 52 are provided in the bottom 50 of the cylinder 20 and in the side of the cylinder 20. The bottom 50 is preferably formed by a plurality of crisscrossing bars with openings 52 between the crisscrossing bars. Openings 52 are preferably also provided in a lower portion of the side to provide improved flow between the upper and lower chambers 28 and 54. The cylinder 20 forms an upper chamber 54. The cylinder 20 is preferably made from Schedule 40 PVC rated to 200 psi, and is preferably a 4″ or 6″ PVC pipe. It is understood that the cylinder 20 may be made from a wide variety of materials, in a wide variety of strength, shapes and sizes.

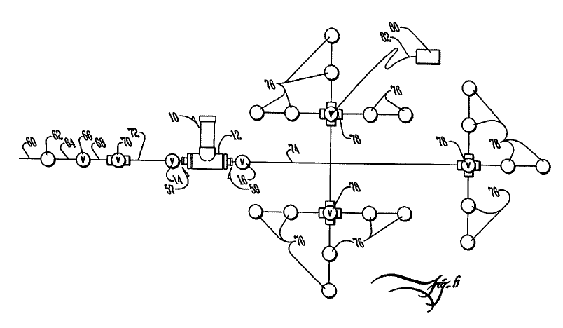

Referring to FIG. 2, the cylinder 20 is secured to the upper opening 22 of the connector 18 such as by gluing to form a watertight seal. The length of the lower portion 34 of the cylinder 20 is selected so that a lower portion of the upper chamber 54 is disposed below an upper portion of the lower chamber 28 and above a lower portion of the lower chamber 28. The lower portion of the lower chamber 28 is unobstructed over substantially its entire length. The bottom 50 of the cylinder 20 is preferably aligned at or near the vertical center of the lower chamber 28. The length of the upper portion 32 of the cylinder 20 is selected so that it extends approximately 15 inches above the center of the lower chamber 28. As best seen in FIG. 5, in an alternate embodiment, the dispenser 12 may be formed as a single piece.

Depending upon the size of the water lines of the irrigation system, the dispenser 12 may further comprise a variety of threaded and unthreaded reducing bushings 56 and nipples 58 that may be secured to the upstream and downstream openings 24 and 26 of the connector 18 to operably connect the powered valves 14 and 16 to the upstream and downstream openings 24 and 26 of the dispenser 12. In one preferred embodiment, a 4″×2″ Schedule 40 PVC reducing bushing 56 is secured to the upstream opening 24 and to the downstream opening 26 of a 4″ tee connector 18, such as by gluing. A 2″×1″ Schedule 40 PVC threaded reducing bushing 56 is secured to each 4″×2″ reducing bushing 56 such as by gluing. A 1″ threaded nipple 58 is secured to each threaded reducing bushing 56. It is understood that the upstream and downstream openings 24 and 26 of the connector 18 may also serve as the upstream and downstream openings 57 and 59 of the dispenser if no bushings 56, nipples 58, or the like are used.

Each powered valve 14 or 16 is preferably an electric solenoid valve, such as a 1″, 24 Volt, AC, 50/60 Hz, 2 Watts, Rainbird® brand valve rated to 150 psi. The powered valves 14 and 16 are secured to the threaded nipples 58 so that the powered valves 14 and 16 are operably connected to the dispenser 12. As the phrase “operably connected” is used herein, it is understood that the powered valve 14 or 16 need not be secured or affixed directly to the tee connector 18 or to a particular bushing 56 or nipple 58. A powered valve 14 or 16 is operably connected to the upstream or downstream opening 57 or 59 of the dispenser 12 as long as the powered valve 14 or 16 is within a few feet of the dispenser 12 and as long as no splits occur in the water line between the powered valve 14 or 16 and the dispenser 12. It is preferred that the powered valve 14 or 16 be secured directly to a nipple 58 or bushing 56 without any additional water line between the powered valve 14 or 16 and the dispenser 12. It is understood that the upstream and downstream openings 57 and 59 of the dispenser 12 may be sized as desired so that the powered valves 14 and 16 may be secured directly to the upstream and downstream openings 57 and 59 of the dispenser 12 without the need for bushings 56, nipples 58, and the like. The powered valves 14 and 16 may be secured in a variety of manners, but for ease of maintenance, repair, and replacement, it is preferred that the powered valves 14 and 16 not be glued to a nipple 58, bushing 56, or connector 18. For greater flexibility, it is preferred to provide a dispenser 12 having a connector 18 with oversized upstream and downstream openings 24 and 26 and to use reducing bushings 56 and the like so that a given dispenser 12 may be provided with a variety of sizes of upstream and downstream openings 57 and 59 so that it may be used in connection with a wide range of water line sizes.

As best seen in FIG. 6, the lawn chemical application system 10 of the present invention is integrated with or incorporated into an underground irrigation system. The lawn chemical application system 10 of the present invention is typically housed underground in a water meter box, with only the top of the water meter box visible at ground level. A water line 60, such as a city water line, provides a source of water for the irrigation system. The water line 60 typically connects to a water meter 62. Another line 64 passes from the water meter 62, through a gate valve 66, through line 68, and to an RPZ valve 70. The RPZ valve 70 prevents water from the irrigation system from flowing back into the water line 60 from the water source, for example preventing the flow of possibly doped water from the PVC pipes of a sprinkler system back into a city water supply. A short line 72 passes from the downstream side of the RPZ valve 70 to the upstream side of powered valve 14. The dispenser 12 is operably connected to the downstream side of valve 14, and valve 16 is operably connected to the downstream side of the dispenser 12. A water line 74 passes from the downstream side of valve 16. The water line 74 may be divided and passed to one or more sprinkler heads 76 in one or more watering zones using a variety of feed lines and valve boxes 78. The present system 10 may be used to replace a master valve of an existing irrigation system or in place of a master valve in a new irrigation system.

Typical water supply lines supply water at a wide range of pressures, such as from approximately 70 psi to approximately 110 psi. Although the system 10 is designed to withstand greater pressures, it is preferred to keep the water supply at or below approximately 120 psi. Pressure regulators may be used as needed, preferably upstream of the RPZ valve 70, to avoid pressures exceeding approximately 120 psi.

A controller 80 is operably connected to the various valves and valve boxes 78, preferably by wiring 82. The controller 80 is preferably positioned in a convenient place such as in or near a house or similar structure. Conductors 84 from valve 14 and valve 16 are in electrical contact with the controller 80 and with each other so that an electrical signal from the controller 80 will simultaneously open the valves 14 and 16 and so that an electrical signal from the controller 80 will simultaneously close the valves 14 and 16. It is understood that the powered valves 14 and 16 may be independently coupled to the controller 80 and may communicate with the controller 80 and with each other in a wide variety of ways including using wires and/or wireless communication. It is further understood that the powered valves 14 and 16 need not be linked to any central controller 80 at all as long as the powered valves 14 and 16 may be opened and closed when desired. It is also understood that the valves need not be opened or closed simultaneously.

The size of the dispenser 12 is selected based upon the size of the area to be serviced by the irrigation system. For example, a dispenser 12 having a 4″ cylinder 20 will hold approximately 5 lbs. of soluble matter or other chemicals, which should be sufficient for most residential uses. A dispenser 12 with a 6″ cylinder 20 will hold approximately 15 lbs. of soluble matter or other chemicals, which should be sufficient for most commercial uses. It is understood that larger or smaller dispensers may be used as desired.

In operation, a user selects a lawn chemical 86 to be applied to the area to be serviced. The system 10 may be used to apply a wide variety of lawn chemicals, including but not limited to soluble matter, and including but not limited to fertilizer, herbicides, pesticides, insecticides, fungicides, disinfectants, nutrients, and the like. The lawn chemical 86 may take any number of forms including but not limited to liquid, granular, tablets, pellets, and blocks. The user removes the lid 38 from the cylinder 20, after using the pressure release means 42-48 if necessary, and places the lawn chemical 86 in the upper chamber 54 formed by the cylinder 20. The lawn chemical 86 may be placed directly into the upper chamber 54, or a container 88 such as a bag or canister containing the lawn chemical 86 may be placed into the upper chamber 54. For ease of packaging, storage, transportation, and use, in one preferred embodiment, the lawn chemical is in a container 88 such as a bag that is housed inside a perforated canister. The user then replaces the lid 38.

The user actuates the system, such as using a controller 80. The controller 80 simultaneously opens powered valves 14 and 16 allowing water to flow from line 60, through the water meter 62, line 64, gate valve 66, line 68, and RPZ valve 70. From the RPZ valve 70 the water passes through line 72, through powered valve 14, and into the dispenser 12. In the dispenser 12, a portion of the water passes through the openings 52 in the bottom 50 and sides of the upper chamber 54 and passes into the upper chamber 54 where the water dissolves or is otherwise doped with the lawn chemical 86 stored in the upper chamber 54. A solution or mixture of the water and lawn chemical 86 then passes from the upper chamber 54 to the lower chamber 28 before passing from the downstream side of the dispenser 12, through powered valve 16, and through line 74. The water and lawn chemical 86 contained therein then pass to one or more sprinkler heads 76 for application to a lawn or other area to be treated. After a desired amount of water or lawn chemical 86 is applied, or after a desired amount of time has passed, the user or controller 80 simultaneously closes powered valves 14 and 16. The closed upstream powered valve 14 discontinues the flow of water into the dispenser 12 from the line 60, water meter 62, line 64, gate valve 66, line 68, RPZ valve 70, and line 72. The downstream powered valve 16 helps seal water and unused lawn chemicals 86 within the dispenser 12. It is of course understood that the system 10 may be used with or without the powered valves 14 and 16 or with only one of the powered valves 14 and 16 being used.

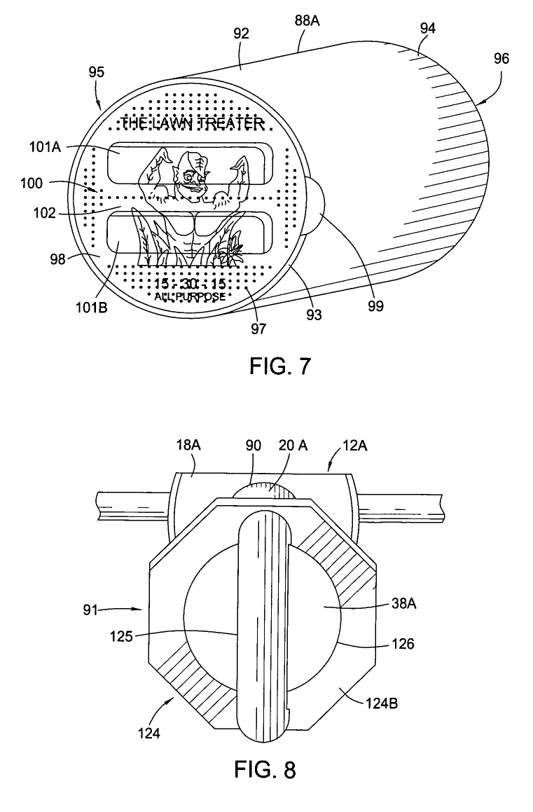

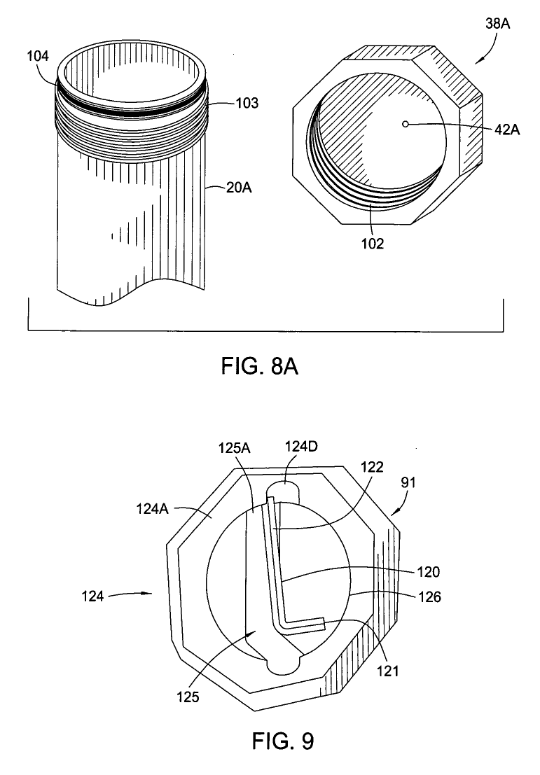

FIGS. 7 and 13 show an embodiment of a container 88A usable in the dispenser 12 shown in FIGS. 1-5 or in the dispenser 12A shown in FIGS. 8-12 (described below), in generally the same manner that the use of the container 88 in the dispenser 12 is described above. The container 88A, which may be a cartridge or canister for storing and dispensing the lawn chemical 86 or 86A to be applied to the area to be serviced, is formed from one or more tubular bodies 92 operably connected to one another, the tubular bodies 92 having a first opening at its first end 93 and a second opening at its second end 94. Preferably, as shown in FIG. 7, only one tubular body 92 forms the container 88A. The one or more tubular bodies 92 may be formed of any material known to those skilled in the art capable of containing a lawn chemical, for example a plastic or metal material, or a piece of PVC pipe.

The ends 93 and 94 of the container 88A are at least partially obstructed by a first end cap 95 and a second end cap 96 (shown particularly in FIG. 13). The first end cap 95 is sized so that its inner diameter securely fits around an outer diameter of the first end 93, while the second end cap 96 is sized so that its inner diameter securely fits around an outer diameter of the second end 94. Preferably, these secure fits between end caps 95, 96 and ends 93, 94 are attained by the resulting relatively tight fit of the end caps 95, 96 around the ends 93, 94 upon sliding of the end caps 95, 96 onto their respective ends 93, 94. Of course, in lieu of the slidable fit, the end caps 95, 95 may be threadable to corresponding ends 93, 94 or operably connected to the ends 93, 94 by any manner known to those skilled in the art, including by one or more connecting members such as bolts for connecting the end caps 95, 96 to the ends 93, 94. In an alternate embodiment, either or both of the end caps 95, 96 may be eliminated and the container 88A may instead be formed from only one piece where the container 88A itself extends partially or completely into the space shown as the first and second openings of the container 88A in FIG. 7.

Each end cap 95, 96 includes a plurality of perforations 97 extending therethrough for selectively allowing a predetermined amount of lawn chemical 86 or 86A (not shown in FIG. 7) to exit from a bore of the container 88A, through the perforations 97, and into the dispenser 12 or 12A. Operative parameters of the perforations, such as the total amount of perforations, the size (diameter) of the perforations, the concentration of perforations (e.g., number of perforations per inch of the end cap 95, 96), and/or the pattern of the perforations on the end caps 95, 96 are optimized based upon the desired rate of release of the lawn chemical 86, 86A from the container 88A. These optimal parameters may depend upon the type of lawn chemical 86, 86A residing within the container 88A and its properties (e.g., the outer diameter of the lawn chemical particles, lawn chemical's solubility, etc.). Optimally, the perforations 97 are sized so that the lawn chemical 86, 86A is released at the desirable rate for dispensing the lawn chemical 86, 86A onto the relevant lawn area while preventing the release of sufficient lawn chemical 86, 86A from the container 88A to clog the lawn chemical application system 10 or the irrigation system.

Each container 88A includes a lawn chemical 86, 86A (not shown in FIG. 7) therein, preferably but not necessarily approximately five pounds of lawn chemical 86, 86A. The container 88A is sized to accommodate the desired weight or volume of the lawn chemical 86, 86A (e.g., sized to accommodate five pounds of Miracle-Grog). Preferably, the container 88A and lawn chemical 86, 86A are placed as a unit into the dispenser 12 or 12A, and the entire unit is replaced when desired or needed (for example when the contents of the container 88A are all or mostly dispensed). However, it is within the scope of embodiments to refill the container 88A with additional lawn chemical when desired or needed by simply removing one or both of the end caps 95, 96, placing additional lawn chemical within the bore of the container 88A, and then replacing the end cap(s) 95, 96.

To obstruct flow of the lawn chemical 86 through the perforations 97, for example during transport or storage of the container 88A, a covering member 98 (see FIGS. 7 and 13) may optionally be placed over each end cap 95, 96 so that it at least partially covers the perforations 97. The covering member(s) 98 prevent(s) inadvertent dislodging of the lawn chemical 86, 86A from the container 88A through perforations 97 (and prevent(s) loss of lawn chemical 86, 86A from the container 88A) prior to placement of the container 88A in the dispenser 12, 12A and use of the lawn chemical 86, 86A in the irrigation system. In one embodiment, each covering member 98 is a pliant sheet material, preferably a plastic or paper sheet material, having an adhesive on one of its side surfaces (an adhesive backing). Each covering member 98 is preferably similar in shape to the end cap(s) 95, 96, but may be of any shape capable of covering one or more of the perforations 97, preferably all of the perforations 97. In other embodiments, the covering member(s) 98 need not take the form of a sheet, need not be pliant, and need not have adhesive on any or all of its/their surface(s). Each covering member 98 may include one or more tabs 99 extending therefrom to allow a person to grip the tab(s) 99 to pull and remove the covering member(s) 98 from each end cap 95, 96 when desired or necessary.

One or both of the end caps 95, 96 may optionally include a handle thereon, therewith, or therein to allow the user or another person to grippingly engage and pick up the container 88A using his or her hand, for example to transport the container 88A from one location to another location and to install the container 88A in the dispenser 12 or 12A. In the embodiment illustrated in FIG. 7, a handle 100 is integrated with the first end cap 95. Two spaced-apart indentions 101A, 101B in the outward-facing surface of the first end cap 95 result in the end cap portion 102 located between the indentions forming the handle 100. The handle 100 shown in FIG. 7 may be formed in either or both end caps 95, 96, although in the preferred embodiment, the handle 100 is only formed in the first end cap 95. Any other type of handle 100 may be integrated with or operably attached to either or both end caps 95, 96 in lieu of the depicted handle.

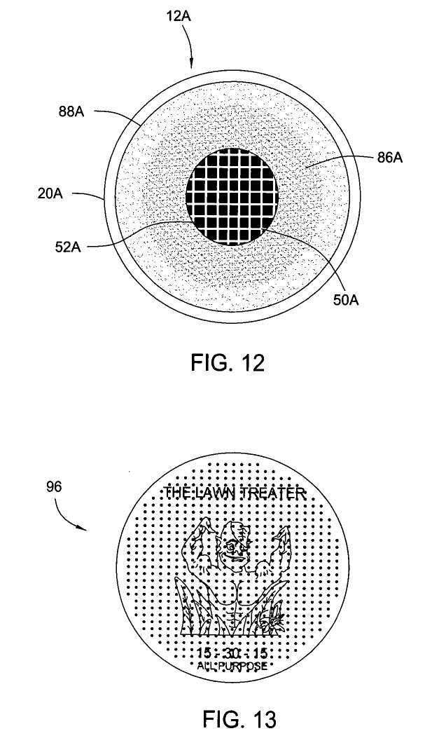

FIGS. 8-8A and 10-12 illustrate an embodiment of a dispenser 12A which may be utilized in lieu of dispenser 12A in the lawn chemical application system 10. In particular, FIG. 12 shows an embodiment of the dispenser 12A where a bottom 50A of the cylinder 20A includes a plurality of openings 52A therein. The bottom 50A may be formed from a plurality of crisscrossing bars with openings 52A therebetween. The bottom 50A is similar to the bottom 50 shown and described in relation to FIG. 4, but in the embodiment shown in FIG. 12, the openings 52A preferably do not extend to the side of the cylinder 20A as in the case of the openings 52 of FIG. 4. Also shown in FIG. 12 is the container 88A having the lawn chemical 130 disposed therein located in the bore of the cylinder 20A. Center portions of the lawn chemical 86A and of the end cap 96 are cut out of FIG. 12 merely to illustrate the mesh bottom 50A of the cylinder 20A (ordinarily the lawn chemical 86A and end cap 96 will prevent view of the bottom 50A when the container 88A exists in the bore of the cylinder 20A).

FIG. 8 illustrates the dispenser 12A where the cylinder 20A and the tee connector 18A are molded together so that the dispenser 12A essentially constitutes and operates as one single piece. Molding the cylinder 20A and tee connector 18A to one another at an intersection point 90 of the cylinder 20A and tee connector 18A prevents erosion of the dispenser 12A at the intersection point 90, thereby protecting against leakage (e.g., water leakage) from and/or into the dispenser 12A. In the embodiment shown in FIG. 8, each entire lawn chemical application system 10 is formed from one single piece (except that the tee connector 18A and the cylinder 20A are molded to one another to act as a unitary piece) with the exception of possibly the reducer(s) and the container 88 or 88A. Also in the embodiment shown in FIG. 8, because the tee connector 18A and cylinder 20A are molded together, the portion of the tee connector 18 which extends parallel to the cylinder 20 in the embodiment of FIG. 2 is not needed (although it is contemplated that other embodiments may include this extension to the tee connector 18); thus, the tee connector 18A is preferably essentially a cylinder having a hole therethrough where an end of the cylinder 20A is molded so that a central axis of the tee connector 18A cylinder is aligned generally perpendicular to a central axis of the cylinder 20A and the lower end of the cylinder 20A is molded around or within the hole in the tee connector 18A cylinder. Also in the embodiment shown in FIG. 8, the cylinder 20A does not include different outside diameter portions 32, 34, and the cylinder 20A and tee connector 18 do not include shoulders 30 and 36 (although any or all of these features may be included in other embodiments). These features are not necessary to retain the cylinder 20A and the tee connector 18A with one another because the two components are molded to one another in the embodiment of FIG. 8.

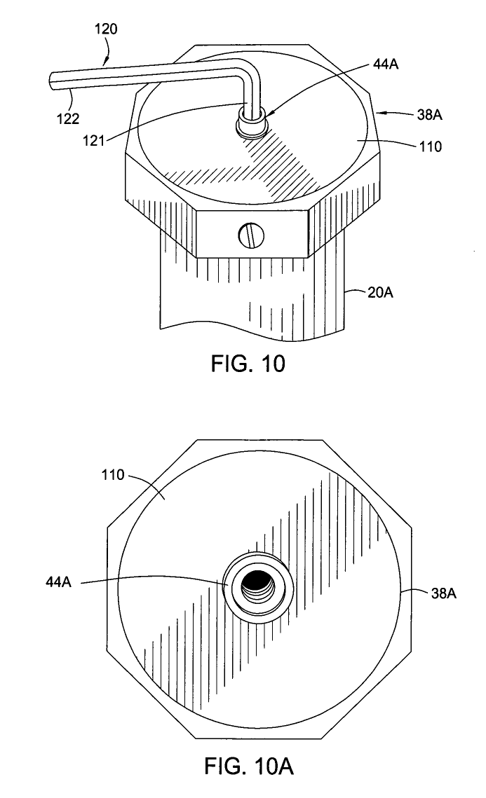

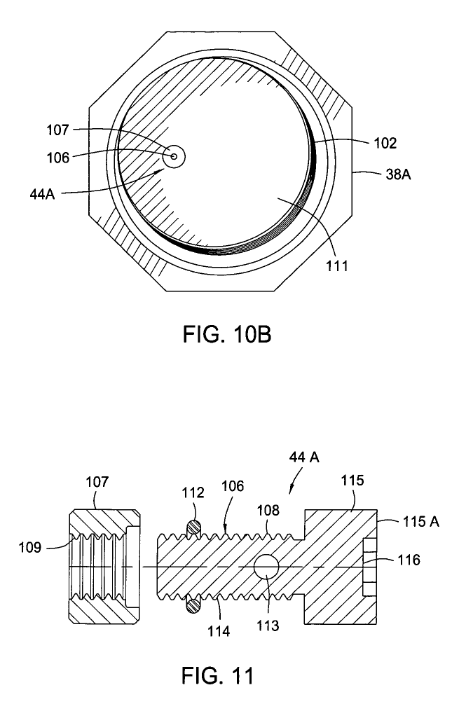

FIG. 8 also shows a lid-manipulating device 91 which is capable of opening and closing a lid 38A of the dispenser 12A (or the lid 38 of the dispenser 12). The lid 38A is shown in FIGS. 8, 8A, 10, 10A, and 10B. The lid 38A is operably and sealably connectable to an upper end of the cylinder 20A to allow build-up of water pressure within the dispenser 12A for its operation within the irrigation system, to prevent explosion of the contents of the dispenser 12A out the upper end of the cylinder 20A upon operation of the irrigation system, and/or to temporarily or permanently restrict access to the bore of the dispenser 12A.

FIG. 8A shows a view of the inside of the lid 38A and the portion of the cylinder 20A to which the lid 38A is connectable. An inner diameter of the inside of the lid 38A is generally circular to correspond with an outer diameter of the cylinder 20A. Although the lid 38A may be connected to the cylinder 20A in any manner known to those skilled in the art, the preferred embodiment shown in FIG. 8A involves using a threadable connection to connect the lid 38A to the cylinder 20A. To this end, the inner diameter of the lid 38A has internal threads 102 thereon, while the outer diameter of the cylinder 20A includes external threads 103 thereon. Upon turning of the lid 38A with respect to the cylinder 20A in a direction when the lid 38A is placed on the cylinder 20A, the internal and external threads 102, 103 mate with one another to form a threaded connection. Rotating the lid 38A in the opposite direction disengages the threads 102, 103 from one another to disconnect the lid 38A from the dispenser 12A. Of course, in alternate embodiments the lid 38A may include external threads and the cylinder 20A may possess internal threads.

To provide a sealed connection between the lid 38A and cylinder 20A, one or more sealing members 104 may optionally be disposed at or near the connection therebetween. Preferably, the sealing member 104 is located at the threaded connection among the threads 102 and/or 103. In one embodiment, the sealing member 104 is a circular o-ring capable of positioning among the male threads 103 of the cylinder 20A. In other embodiments, multiple circular O-rings may be placed among the threads and/or multiple seals may be spaced around the outer diameter of the cylinder 20A. Regardless of the configuration of the sealing member(s) 104, its/their purpose is to sealedly connect the lid 38A and the cylinder 20A to one another to prevent the escape of water pressure from the dispenser 12A at their connection point and to provide a water-tight seal between the lid 38A and cylinder 20A. The use of one or more O-rings around male threads 103 of the cylinder 20A instead of rubber washer(s) around the lid 38A advantageously prevents the lid 38A from unthreading due to expansion of the rubber washer (to avert the undesirable un-threading of the lid 38A when the rubber washer is used around the lid 38A often requires the threaded connection between the lid 38A and the cylinder 20A to be so tight that manual removal of the lid 38A from the cylinder 20A is difficult if not impossible).

Optionally, an opening 42A (which may be internally threaded) extends through the top of the lid 38A. The threaded opening 42A is much like the threaded opening 42 described above in relation to FIG. 2. A pressure release mechanism 44A (which also may double as a locking mechanism) as shown in FIGS. 10B and 11 is disposable within the opening 42A to allow selective, measured release of pressure (water pressure) from within the dispenser 12A as needed. The pressure release mechanism 44A also provides an effective safety lock to prevent children or other unauthorized users access to the inside of the dispenser 12A because the pressure release mechanism 44A requires a special pressure release tool for its unthreading from the lid 38A.

The embodiment of the pressure release mechanism 44A shown in FIG. 111 includes a releasing member 106 and a receiving member 107. The releasing member 106 provides the pressure release when manipulated and is capable of sealably connecting with the receiving member 107. The releasing member 106 includes one or more threads 108 (which may be external threads) thereon or therein, while the receiving member 107 includes one or more threads 109 (which may be internal threads) thereon or therein. When a portion of the releasing member 106 is located through a top, outer surface 110 of the lid 38A within its opening 42A, external threads 108 of the releasing member 106 mate with internal threads 109 of the receiving member 107 when the receiving member 107 is disposed below the inner surface 111 of the lid 38A with its central axis generally in line with a central axis of the opening 42A.

One or more sealing members 112 may be disposed around an outer diameter of the releasing member 106 at or near the threads 108. Upon threading of the releasing member 106 into the receiving member 107, the sealing member(s) 112 provide a water-tight seal to prevent pressure release at the connection point between the releasing and receiving members 106, 107. The one or more sealing members may include one or more O-rings and/or any other sealing members known to those skilled in the art.

The releasing member 106 is preferably a bolt, screw, or other similar fastening member having a connecting portion 114 for inserting into the receiving member 107 and into the opening 42A (e.g., a pin or rod) and a stop shoulder 115 (e.g., a bolt or screw head) with an outer diameter larger than an outer diameter of the connecting portion 114. The receiving member 107 is preferably a nut or other member known to those skilled in the art having internal threads capable of fitting around or securing a bolt or screw upon application of torque to the bolt/screw. The connecting portion 114 possesses a longitudinal bore through at least a portion thereof so that the releasing member 106 is a hollow tubular body from its end up to its pressure-releasing hole(s) 113. The connecting portion 114 includes these one or more pressure-releasing holes 113 therethrough so that the bore of the connecting portion 114 is exposed at the hole(s) 113. In an upward-facing surface 115A of the shoulder 115, a groove 116 is formed. The groove 116 is shaped to permit unthreading and threading of the releasing member 106 from the internal threads 109 and the opening 42A using a special pressure release tool, for example a pressure release tool 120 as depicted in FIGS. 9-10.

The opening 42A through the lid 38A is threaded to allow the threads 108 to mate with threads of the opening 42A. The threads of the opening 42A may be disposed in the same direction as the threads 109 of the receiving member 107 so that the threads 108 of the releasing member 106 are capable of threadedly connecting to both the opening 42A (and therefore the lid 38A) and the receiving member 107. In the embodiment shown in FIGS. 10-11, the threads of the opening 42A are internal threads.

To prevent the releasing member 106 from unthreading from the receiving member 107 and the opening 42A during the operation of the lawn chemical application system due to pressure build-up within the dispenser 12A, the pressure release mechanism 44A and the threads disposed in the opening 42A may be reverse-threaded. Reverse-threading the pressure release mechanism 44A and the opening 42A involves locating the threads on the pressure release mechanism 44A and opening 42A so that rotating the releasing member 106 clockwise un-threads (threadedly disconnects) the releasing member 106 from the receiving member 107 and the opening 42A, while rotating the releasing member 106 counter-clockwise threads (threadedly connects) the releasing member 106 into the receiving member 107 and opening 42A. This reverse-threading is opposite from the normal threading of a releasing member 106 and receiving member 107 where clockwise rotation of the releasing member 106 threads (connects) the releasing member 106 to the receiving member and where counter-clockwise rotation of the releasing member 106 un-threads (disconnects) the releasing member 106 from the receiving member 107.

The pressure release mechanism 44A allows pressure release from the dispenser 12A, which reduces the force required to open the lid 38A by rotation and gain access to the inside of the dispenser 12A. Therefore, to open the lid 38A, a person may first unthread the releasing member 106 from the receiving member 107 and opening 42A until at least a portion of the pressure-releasing hole(s) 113 are disposed above the opening 42A. Exposing the pressure-releasing hole(s) 113 to the atmosphere allows pressure to exit from the dispenser 12A via the bore of the releasing member 106 through the hole(s) 113, making the lid 38A easier to open due to decreased pressure within the bore of the dispenser 12A.

As alluded to above, the groove 116 in the releasing member 106 is shaped to permit the pressure release tool 120 to fit therein and rotate the releasing member 106 upon rotation of the tool 120. The pressure release tool 120 is shown located in the groove 116 in FIG. 10, and tool 120 is also shown in FIG. 9. The pressure release tool 120 is preferably an allen wrench having an L-shaped bar with a hexagonal head used to turn screws with hexagonal sockets (grooves 116) where the shape of the groove 116 is hexagonal, but the tool 120 may include a head 121 of any shape capable of fitting into the groove 116 of the head (shoulder 115) of the releasing member 106. The pressure release tool 120 may be constructed of any material known to those skilled in the art with sufficient strength and hardness to rotate the releasing member 106 via the groove 116, for example a metal or hard plastic material. As shown in FIG. 10, to provide torque to the releasing member 106, an end of the head 121 of the pressure release tool 120 is placed in the groove 116, and the user grips a handle 122 of the tool 120 and uses the handle 122 to rotate the tool 120, thereby causing the head 121 to engage and rotate the releasing member 106.

In the shown embodiment of the lid 38A (see FIGS. 8-8A, 10-10B), an outer diameter/outer surface of the lid 38A is octagonally-shaped to permit a correspondingly-shaped lid-manipulating device 91 (see FIGS. 8, 9, 10) to grip the outer diameter of the lid 38A for opening or closing the lid 38A, as shown in FIG. 8. Any other shape of lid 38A is capable of use with embodiments, including any lid 38A which provides a gripping surface for the lid-manipulating device 91, for example a lid having any number of sides (triangle, rectangle, square, pentagon, hexagon, decagon, etc.) and shapes, a lid having grooves or protrusions around its outer diameter for mating with corresponding grooves or protrusions around the inner diameter of the lid-manipulating device, and/or a lid having a gripping surface such as rubber externally applied around its outer diameter.

The lid-manipulating device 91, which is preferably a wrench, reduces the force required to open or tightly close the lid 38A by providing increased torque (with respect to the torque a human is capable of applying to the lid 38A without the aid of the device) to the lid 38A to effect threaded connection/disconnection of the lid 38A to/from the dispenser 12A. The lid-manipulating device 91 may include a body 124, the inner surface 124A of which is shaped to grippingly engage the lid 38A, and a handle 125 operatively connected to or integral with an outer surface 124B of the lid 38A to allow a person to grip the handle 125 to rotate and provide torque to the lid-manipulating device 91 to open or close the lid 38A. The lid-manipulating device 91 may be formed of any material known to those skilled in the art which is capable of turning the lid 38A upon application of rotational force thereto, for example plastic or metal.

In the embodiment shown in FIGS. 8 and 9, the body 124 of the lid-manipulating device 91 includes an optional cut-out portion 126. This optional cut-out portion 126 eases access to the pressure release tool 120 when it is optionally releasably connected to the lid-manipulating device 91. Referring now to FIG. 9, an inner surface 125A of the handle 125 may be recessed (and/or the inner surface 124A may optionally include a recessed portion 124D therein) for releasably holding the tool 120 therein. One or more locking members (not shown) may extend into the recessed inner surface 125A (and/or the recessed portion 124D) to lockingly hold the tool 120 with the lid-manipulating device 91 so that the two unlocking devices (the tool 120 and device 91) may be conveniently transported and stored together as a unit.

Operation of the lawn chemical application system where the container 88A of FIG. 7 is utilized as the source of the lawn chemical 86 or 86A is substantially similar to the description above in relation to the use of a perforated canister (preferably without the bag housed inside the perforated container), where the user removes the lid 38 or 38A (e.g., using the lid-manipulating device 91 and/or pressure release tool 120), locates the container 88A in the cylinder 20 or 20A, and replaces the lid 38 or 38A (e.g., also using the lid-manipulating device 91 and/or the pressure release tool 120). If either or both of the end caps 95, 96 are covered with covering member(s) 98, then the covering member(s) 98 is/are removed by peeling it/them back from the end cap(s) 95, 96 before replacing the lid 38 or 38A. After actuation of the system as described above in relation to FIGS. 1-6, the portion of the water passes through openings 52 or 52A (see FIG. 12) in the bottom 50 or 50A (and/or in the sides, in the case of cylinder 20) of the cylinder 20 or 20A. The water then passes through the container 88A via perforations in the second end cap 96 (see FIG. 13) and dissolves or is otherwise doped with the lawn chemical 86 or 86A stored in the cylinder 20 or 20A before it exits back through the perforations, back through the openings 52 or 52A and into the lower chamber 28, and into the downstream side of the dispenser 12 or 12A. When the lawn chemical 86 or 86A needs to be replaced, the user removes the lid 38 or 38A (e.g., using the lid-manipulating device 91 and/or the pressure release tool 120), removes the container 88A from the dispenser 12 or 12A, inserts another container (not shown) of lawn chemical 86 or 86A, and replaces the lid 38 or 38A on the dispenser 12 or 12A (e.g., also using the lid manipulating device 91 and/or the pressure release tool 120). In an alternate embodiment, the container 88A may be refilled with lawn chemical 86 or 86A and re-placed in the dispenser 12 or 12A rather than replacing the container 88A with another container of lawn chemical. Other than the above-described operation of installing and replacing the container 88A and the dissolving or doping the lawn chemical 86 or 86A into the water using the container 88A, the operation of the system of FIGS. 7-13 when using the container 88A is at least substantially similar or the same as the operation of the lawn chemical application system described above in relation to FIGS. 1-6.

The opening and closing of the lid 38A depicted in FIGS. 8-8A and 10-10B may proceed as follows. To close the lid 38A, the lid 38A is placed atop the cylinder 20 or 20A so that threads 102 of the lid 38A are aligned with threads 103 of the cylinder 20 or 20A. The lid 38A is rotated, preferably in the clockwise direction, until an at least substantially water-tight fit between the lid 38A and the cylinder 20 or 20A is achieved. Rotation may be effected by any means known to those skilled in the art, but is preferably manually accomplished by the user and then, if necessary, the lid 38A is further rotated and tightened using an external tool such as the lid-manipulating tool 91. In the alternative, the external tool may be used to tighten the lid 38A from the beginning.

Using the lid-manipulating tool 91 allows the user to impart more rotational force to the lid 38A than is ordinarily possible manually and lessens the amount of rotational force the user must apply to effectively seal and tighten the lid 38A and cylinder 20, 20A connection. To rotate the lid 38A with the tool 91, the pressure release tool 120 is removed from the inside 125A of the handle 125 (if necessary), the user grips the handle 125, the inner surface 124A of the lid-manipulating tool 91 is located on the lid 38A so that the inner surface shape of the lid-manipulating tool 91 is matched with the corresponding outer perimeter shape of the lid 38A, and the user rotates the handle 125 to provide increased rotational force to the lid 38A with respect to the cylinder 20 or 20A.

When the lid 38A is tightly connected to the cylinder 20 or 20A, if releasing member 106 of the pressure release mechanism 44A is not completely threaded into the receiving member 107 or opening 42A, the releasing member 106 is then rotated (preferably in the counter-clockwise direction) by impartation of rotational force thereto with respect to the receiving member 107 and opening 42A to further pressure seal the dispenser 12 or 12A. The user may impart manual rotational force to the releasing member 106, and then the pressure release tool 120 may be used to optionally further tighten the pressure releasing member 106. In the alternative, the tool 120 may be used to torque the pressure releasing member 106 from the beginning.

Operation of the pressure release tool 120 to tighten the threaded connection between the pressure releasing member 106 and the receiving member 107 and threaded opening 42A involves the following: the user grips the handle 122 of the pressure release tool 120 (after the pressure release tool 120 is removed from its releasable connection with the lid-manipulating device 91) and inserts the head 121 of the tool 120 into the groove 116 in the releasing member 106 so that the outer perimeter shape of the tool head 121 fits within the corresponding shape of the groove 116, as depicted in FIG. 10. The user then grippingly engages the handle 122 to rotate the handle 122 of the tool 120 around the head 121/receiving member 106 (preferably in a counter-clockwise direction to tighten), thereby rotating the head 121 and releasing member 106 with respect to the lid 38A and the receiving member 107, until the threaded connection between the releasing member 106 and the receiving member 107 and opening 42A is sufficiently tightened and pressure sealed. The tool 120 may then be removed from the groove 116.

To remove/open/unthread the lid 38A, the lid 38A and optionally the releasing member 106 are rotated in the opposite direction from the direction used in closing/threading the lid 38A. If necessary or desirable, the pressure release mechanism 44A is employed to release some water pressure from within the dispenser 12 or 12A prior to removing/opening the lid 38A. To use the pressure release mechanism 44A to relieve at least some of the pressure from within the bore of the dispenser 12 or 12A and thereby decrease the amount of force required to rotate the lid 38A itself, the releasing member 106 is rotated (preferably in a clockwise direction) to unthread the releasing member 106 from the receiving member 107 and threaded opening 44A until at least a portion of the pressure-releasing hole(s) 113 is exposed above the opening 44A. The hole(s) 113 allow water release from the bore of the cylinder 20 or 20A, through the bore of the receiving member 107, through opening 44A, and through the bore of the releasing member 106 to the hole(s) 113. Again, the rotational force may be imparted to the releasing member 106 in the same manner as described above by the user directly grippingly engaging and rotating the releasing member 106 and/or by the user grippingly engaging and rotating the releasing member 106 via the tool 120. When adequate pressure release occurs by employing the pressure release mechanism 44A, the lid 38A may be rotated in the opposite direction from the direction of rotation for closing the lid 38A by the user directly and/or by the user via the lid-manipulating device 91, as described above.

The pressure release mechanism 44A may be employed to relieve water pressure in the system when desired or necessary, even during operation of the system, independent of whether the lid 38A is opened or removed from the cylinder 20 or 20A. When the lid-manipulating device 91 and the pressure release tool 120 are not in use, they may optionally be releasably connected to one another by snapping the tool 120 into the inside 125A of the handle 125 (see FIG. 9) between locking tabs (not shown).

The pressure release mechanism 44A acts not only as a lid-loosener and pressure releaser, as described above, but also acts as a safety lock (e.g., a child safety lock or a lock to prevent inadvertent or unauthorized access to the interior of the dispenser 12 or 12A) because the lid 38A is very difficult to remove without releasing water pressure using the pressure release mechanism 44A. Therefore, one would have to know of the requirement to torque the pressure release mechanism 44A as well as probably have to use a special tool to rotate the pressure release mechanism 44A, so that a child, for example, could not open the lid 38A by merely turning the lid 38A without manipulating the pressure release mechanism 44A. Likewise, the lid 38A itself may also act as an access/safety lock because it may be difficult or impossible to remove/loosen without the use of the lid-manipulating device 91.

Embodiments include a dispenser comprising a first cylinder and a second cylinder operatively connected generally perpendicular to one another, the operative connection being at or near an end of the first cylinder and within a body of the second cylinder. The operative connection may be by molding the first and second cylinder to one another. In other embodiments, the dispenser may include one single cylinder in the configuration of a connected first and second cylinder as described above. Either of these embodiments may be included in an irrigation system. The irrigation system may be one single unit (may be all molded together or formed from one piece of pipe or other material) except for the container to be placed within the dispenser and the reducers. In some embodiments, the first and/or second cylinder(s) may be a tee connector.

Embodiments include a dispenser comprising a first cylinder having an upper opening, the first cylinder forming a lower chamber, and a second cylinder secured to the upper opening of the first cylinder, the cylinder forming an upper chamber, the upper chamber having a lower portion disposed below an upper portion of the lower chamber and above a lower portion of the lower chamber. In one embodiment, the first and second cylinders are secured by molding them to one another. In an embodiment, the lower portion of the upper chamber comprises a bottom surface having a plurality of openings passing therethrough. The lower portion of the lower chamber may be unobstructed over substantially its entire length.

Embodiments further include a container for placement within any of the above-described dispensers, the container capable of releasably retaining a soluble matter therein. In some embodiments, the container comprises a plurality of perforations through one or more of its ends to allow flow of soluble matter therethrough upon flow of water or another liquid through the container. The container may be refillable with soluble matter by removal of one or more end caps at or near its ends.

Other embodiments include an apparatus comprising a dispenser having a lower chamber, an upper chamber, an upstream opening, and a downstream opening; a first powered valve operably connected to the upstream opening, and a second powered valve operable connected to the downstream opening. The apparatus may include any or all of the above-described features. The upper chamber may comprise a cylinder having a bottom with a plurality of openings passing therethrough. The upper chamber may house a container as described above. The upper chamber may include a lid thereon having any or all of the above-described features.

Further embodiments include an irrigation system, comprising a first water line; an RPZ valve, said first water line being operably connected to an upstream side of said RPZ valve; a second water line operably connected to a downstream side of said RPZ valve; a first powered valve, said second water line being operably connected to an upstream side of said first powered valve; a dispenser operably connected to a downstream side of said first powered valve; a second powered valve operably connected to a downstream side of said dispenser; a third water line operably connected to a downstream side of said second powered valve; and a sprinkler head operably connected to said third water line. The dispenser may include any of the above-described features, including one or more openings through a bottom thereof. One or more containers having soluble matter therein and one or more perforations therethrough for dispensing soluble matter may be disposed within the dispenser. The irrigations system may include a lid removably secured to an upper portion of said cylinder, and may further include pressure release means or a pressure release mechanism operably connected to said lid for releasing pressure from within said cylinder before said lid is removed.

Other embodiments include a method of irrigating an area, comprising (1) providing a dispenser, a first powered valve operably connected to an upstream side of said dispenser, and a second powered valve operably connected to a downstream side of said dispenser; (2) opening said first and second powered valves; (3) passing water through an RPZ valve; (4) after step (3), passing said water through said first powered valve and into said dispenser; (5) after step (4), adding soluble matter to said water; (6) after step (5), passing said water from said dispenser and through said second powered valve; (7) after step (6), passing said water to a sprinkler head; and (8) after step (7), closing said first and second powered valves. The method may include any or all of the above-described steps. The dispenser may comprise one or more cylinders operably connected to one another to form an upper chamber and a lower chamber, and the dispenser may include one or more perforations through a bottom of the lower chamber. The dispenser may be configured to house a container therein, the container having soluble matter therein and one or more perforations therethrough for dispensing soluble matter therefrom. In one embodiment, prior to step (2), the container may be placed within the dispenser. In further embodiments, the container may be at least partially filled with soluble matter prior to its placement within the dispenser. After step (5), the water may be passed through the one or more perforations through an end of the container. In step (6), passing said water from said dispenser may comprise flowing the water through the one or more perforations through the bottom of the lower chamber. In yet further embodiments, a lid may be operably connected to or removed from the dispenser when inserting or removing the container from the dispenser. A pressure release means or mechanism may be manipulated prior to removal and/or connection of the lid from or to the dispenser. One or more special tools may be used to remove or replace the pressure release mechanism and/or the lid.

Embodiments include a lid for use on a dispenser of an irrigation system, the dispenser capable of distributing soluble matter therefrom, comprising an inside surface having one or more connecting members for operatively connecting the lid to the dispenser wherein the lid is capable of at least partially covering an upper chamber of the dispenser when operatively connected thereto; an outer perimeter shaped to allow gripping engagement of the lid to connect or disconnect the lid to or from the dispenser; and an opening therethrough for receiving a pressure release mechanism therein, the pressure release mechanism for releasing pressure from within the dispenser before the lid is removed. In some embodiments, the pressure release mechanism comprises a pressure release member having one or more external threads disposed through the opening; and a receiving member having one or more internal threads capable of threaded connection with the one or more external threads, wherein the receiving member is located below the opening. The pressure release member may include a bolt or screw and the receiving member may include a nut capable of threadedly receiving the bolt or screw. In other embodiments, an external tool for grippingly engaging the outer perimeter of the lid is required to unthread or sufficiently thread the lid onto the dispenser, the tool shaped to correspond with the shape of the outer perimeter. The external tool is a wrench in one embodiment. In yet other embodiments, an external tool is required to unthread or sufficiently thread the pressure release member from the receiving member to release or retain pressure within or from the upper chamber. The external tool may be an alien wrench.

Other modifications, changes and substitutions are intended in the foregoing, and in some instances, some features of the invention will be employed without a corresponding use of other features. For example, only one powered valve 14 or 16 may be used, and the powered valve 14 or 16 may be disposed upstream or downstream of the dispenser 12. The dispenser 12 may take any number of sizes, shapes, and configurations, and may be formed as a single piece, may be formed from the cylinder 20 and tee connector 18 molded together, or may be assembled from a number of components. Also, the system 10 is described as being used in connection with an underground irrigation system, it is understood that the system 10 may be used in combination with any number of forms of watering, including but not limited to use in combination with a garden hose, soaker hose, or the like. Further, the system 10 may be used in connection with the doping and distribution of not only water but also a wide variety of fluids. Accordingly, it is appropriate that the appended claims be construed broadly and in a manner consistent with the scope of the invention.

1. A lid for use on a dispenser of an irrigation system, the dispenser capable of distributing soluble matter therefrom, comprising:
an inside surface having one or more connecting members for operatively connecting the lid to the dispenser wherein the lid is capable of at least partially covering an upper chamber of the dispenser when operatively connected thereto;
an outer perimeter shaped to allow gripping engagement of the lid to connect or disconnect the lid to or from the dispenser; and
an opening therethrough for receiving a pressure release mechanism therein, the pressure release mechanism for releasing pressure from within the dispenser before the lid is removed.

2. The lid of claim 1, wherein the one or more connecting members comprise one or more internal threads capable of connecting with one or more cooperating external threads disposed on an outer surface of the dispenser.

3. The lid of claim 2, wherein an external tool for grippingly engaging the outer perimeter of the lid is required to unthread or sufficiently thread the lid onto the dispenser, the tool shaped to correspond with the shape of the outer perimeter.

4. The lid of claim 1, wherein the pressure release mechanism comprises:
a pressure release member having one or more external threads disposed through the opening;
a receiving member having one or more internal threads capable of threaded connection with the one or more external threads, wherein the receiving member is located below the opening; and
a hole through the pressure release member for selectively releasing pressure from an upper chamber of the dispenser.

5. The lid of claim 4, wherein manipulating the threaded connection between the receiving member and the pressure release member to dispose the hole above the opening releases pressure from the upper chamber.

6. The lid of claim 4, wherein the opening comprises one or more internal threads therein capable of cooperating with the one or more external threads of the pressure release member.

7. The lid of claim 4, wherein the pressure release member and releasing member are reverse threaded.

8. The lid of claim 7, wherein the opening is also reverse threaded.

9. The lid of claim 4, wherein an external tool is required to unthread or sufficiently thread the pressure release member from the receiving member to release or retain pressure within or from the upper chamber.

10. A method of removing a lid from a dispenser of an irrigation system, where the dispenser is capable of distributing soluble matter therefrom, comprising:
providing the lid operably connected to the dispenser so that a chamber of the dispenser is at least substantially pressure sealed;
providing a pressure release mechanism disposed in an opening through the lid;
manipulating the pressure release mechanism to release a measured amount of fluid pressure from the upper chamber; and
disconnecting the lid from the dispenser after releasing the measured amount of fluid pressure from the upper chamber.

11. The method of claim 10, further comprising placing a container having the soluble matter therein into the chamber of the dispenser, the container including a plurality perforations therethrough for selectively dispensing the soluble matter from the container into the irrigation system.

12. The method of claim 11, wherein the container is generally cylindrical in shape and a bore of the cylinder is closed at its ends, and wherein the perforations are disposed through at least one of the closed ends of the container.

13. The method of claim 12, wherein the perforations are patterned and spaced from one another to dispense a predetermined amount of soluble matter therethrough over a predetermined time.

14. The method of claim 10, wherein the pressure release mechanism comprises:
a pressure release member extending through the opening, the pressure release member having external threads thereon and at least one hole therethrough for releasing fluid pressure from the chamber;
a receiving member disposed below the opening and having internal threads therein, the receiving member capable of threadedly receiving the pressure release member therein.

15. The method of claim 14, wherein manipulating the pressure release mechanism to release a measured amount of fluid pressure from the chamber comprises unthreading the pressure release member from the receiving member to expose the fluid pressure within the chamber to the surrounding environment via the at least one hole through the pressure release member.

16. The method of claim 15, wherein manipulating the pressure release mechanism to release a measured amount of fluid pressure from the chamber comprises using a wrench to unlock the pressure release mechanism from the lid and release pressure via the hole.

17. The method of claim 10, wherein disconnecting the lid from the dispenser comprises rotating the lid with respect to the dispenser, thereby unthreading internal threads of an inside surface of the lid from external threads of an outer surface of the dispenser.

18. The method of claim 17, wherein the disconnecting of the lid from the dispenser is accomplished using a wrench having a corresponding shape to an external surface of the lid.

19. A tool for removing a lid from a dispenser for an irrigation system, the dispenser capable of receiving a soluble matter therein and dispensing the soluble matter therefrom, comprising:
a first wrenching mechanism shaped to correspond with an outer perimeter of the lid and capable of rotating the lid upon application of torque to the first wrenching mechanism; and
a second wrenching mechanism having a head capable of corresponding with and providing torque to rotate a pressure release mechanism disposed through a hole of the lid, the second wrenching mechanism releasably connectable to the first wrenching mechanism.

20. The tool of claim 19, wherein the second wrenching mechanism is releasably connected to the first wrenching mechanism at or near an inside surface of a handle of the first wrenching mechanism via one or more tabs.
